(19) United States
(12) Patent Application Publication
(10) Pub. No.: US 2025/0296177 A1
(43) Pub. Date: Sep. 25, 2025

(54) DATA COMMUNICATION IN LASER PROCESSING SYSTEMS

(71) Applicant: Hypertherm, Inc., Hanover, NH (US)

(72) Inventors: Brenda Melius, Acworth, NH (US); Kenneth J. Woods, New London, NH (US); Clifford Glenn Darrow, Lyme, NH (US); David J. Cook, Bradford, VT (US); Marty Midura, Enfield, NH (US); Scott Almstrom, Lebanon, NH (US); Guy T. Best, Bethel, VT (US); Faraz Mehdi, Lebanon, NH (US); Fulvio Raffa, Bologna (IT); Minah Puddy Wheatley, Minneapolis, MN (US)

(21) Appl. No.: 19/084,009

(22) Filed: Mar. 19, 2025

Related U.S. Application Data
(60) Provisional application No. 63/567,237, filed on Mar. 19, 2024.

(51) Int. Cl. B23K 26/70

(52) U.S. Cl. CPC B23K 26/705; B23K 26/703

(57) ABSTRACT

A laser nozzle for a thermal processing torch located in a thermal processing system is provided. The laser nozzle comprises a body defining a central bore extending along a central longitudinal axis of the body from a proximal end to a distal end of the body. The central bore has an exit orifice and is configured to conduct a laser beam to a workpiece via the exit orifice. The laser nozzle also includes a data tag coupled to the body or integrated with the body. The data tag comprises a data storage device. The laser nozzle further includes a thermal regulation component coupled to the body or integrated with the body. The thermal regulation component is located adjacent to the data tag to provide cooling to the data tag during a torch operation, thereby enabling the data storage device to be readable by a data transceiver during the torch operation.

### CROSS REFERENCE TO RELATED APPLICATION

This application claims the benefit of and priority to U.S. Provisional Patent Application No. 63/567,237 filed on Mar. 19, 2024, the entire content of which is owned by the assignee of the instant application and incorporated herein by reference in its entirety.

### TECHNICAL FIELD

The present invention generally relates to thermal processing systems and more particularly to systems, methods and devices for data communication with a laser nozzle of a thermal processing system.

### BACKGROUND

Thermal processing systems, such as laser processing systems, are widely used in the heating, cutting, gouging and marking of materials. Currently, operations of industrial cutting solutions with laser processing systems rely on talented, experienced and skilled operators to diligently set up, program, maintain and install consumables in these systems, as well as monitor these systems. This is particularly complex and problematic because laser processing systems can operate with a variety of different consumables (e.g., nozzles) requiring their own specific settings (e.g., gases, cut speeds, etc.) and have their own lifecycles. Due to the multitude of options and the overall system setup complexity, a host of issues are commonly encountered in the field, along with mistakes that can be made if the laser processing systems are not fully leveraged to their capabilities.

For instance, consumables for laser processing systems are typically manually selected and loaded into automatic laser consumable changers and often with incorrect consumables for the desired cut applications. Since laser processing systems do not know the temperature of the consumables and therefore cannot detect nor react to overheating, this can lead to consumable failures (e.g., nozzle failures) and result in negative cutting outcomes. With the high level of experience and technical expertise required to maintain and set up these laser processing machines, it can be difficult to identify consumables (e.g., nozzles or holders) and their attributes (e.g., fault history, damage, identification data, usage history, thermal exposure, thermal cycles, and/or brand) for the purpose of selecting the appropriate consumables to install. In addition, there is no data communication between the tech table (e.g., a cut chart or machine programmed process) and the consumables loaded into a laser processing system. Therefore, laser consumables (e.g., a nozzle) are often operated with sub-optimal and/or damaging settings that are intended for different types of consumables.

In particular, laser nozzles (a type of laser consumable) are designed to be small and light to facilitate their installation onto laser cutting heads and allow for quick movements during operations. However, laser nozzles are frequently exposed to extreme thermal loads (e.g., very high temperatures) during operations. Therefore, installing data devices with consumable recognition, sensors, and/or other data features on laser nozzles can be difficult for commercialization due to excessive heat conditions and size requirements.

Therefore, to reduce installation errors and laser processing system setup complexity, there is a need for systems and methods that enable installation and operation of data devices on laser nozzles capable of withstanding harsh operating environments.

### SUMMARY

The present invention, in some embodiments, features methods and devices for two-way communication of data between a laser nozzle and an external laser processing component of a laser processing system. In one aspect, the present application features a laser nozzle for a thermal processing torch located in a thermal processing system. The laser nozzle comprises a body defining a central bore extending along a central longitudinal axis of the body from a proximal end to a distal end of the body. The central bore has an exit orifice and is configured to conduct a laser beam to a workpiece via the exit orifice to process the workpiece in a torch operation. The laser nozzle also includes a signal device coupled to the body or integrated with the body. The signal device comprises a data storage element. The laser nozzle further includes a thermal regulation component coupled to the body or integrated with the body. The thermal regulation component located adjacent to the signal device to provide cooling to the signal device during the torch operation, thereby enabling the data storage element of the signal device to be readable by a data transceiver during the torch operation.

In another aspect, a method is provided for thermally regulating a signal device coupled to or integrated with a body of a laser nozzle. The laser nozzle is located in a cutting head of a laser processing torch of a laser processing system. The method comprises conducting a fluid through a central bore of the body of the laser nozzle along a central longitudinal axis of the body to support conduction of a laser beam through the central bore. The method also comprises cooling, by a thermal regulation component coupled to the body or integrated with the body, the signal device. The method further comprises cutting, by the laser beam, a workpiece in a torch operation and enabling the signal device to be read by a data transceiver during the torch operation. The data transceiver can be located external to the cutting head.

In some embodiments, cooling the signal device comprises flowing a coolant fluid into at least one inlet in the laser nozzle that is radially offset from the central bore. The inlet is fluidly connected to the at least one coolant passage of the thermal regulation component. Cooling the signal device also comprises directing the coolant fluid to flow proximate the signal device via the at least one coolant passage and exhausting the coolant fluid from the body via at least one outlet of the laser nozzle, the outlet fluidly connected to the at least one coolant passage. In some embodiments, the method further includes flowing the coolant fluid through the at least one inlet, the at least one coolant passage and the at least one outlet without intermingling with the fluid conducted through the central bore. In some embodiments, exhausting the coolant fluid comprises recirculating the coolant fluid into a laser head connected to the laser nozzle or exhausting the coolant fluid to atmosphere. In some embodiments, directing the coolant fluid by the at least one coolant passage comprises directly impinging the coolant fluid on at least one surface of the signal device.

In yet another aspect, the present invention features a replaceable consumable component of a thermal processing torch located in a thermal processing system. The replaceable consumable component comprises a thermally conductive body defining a central bore extending along a central longitudinal axis of the body from a proximal end to a distal end of the body. The central bore has an exit orifice and is configured to conduct a laser beam to a workpiece via the exit orifice during an operation of the thermal processing torch. The replaceable consumable component also includes a signal device disposed in the thermally conductive body and an insulator comprising a thermally insulating material. The insulator is disposed between the thermally conductive body and the signal device to thermally regulate the signal device. The signal device is readable by a data transceiver positioned greater than about one foot away from the body during the torch operation.

Any of the above aspects can include one or more of the following features. In some embodiments, the laser beam produces at least about 2,000 Watts of power. In some embodiments, the signal device includes a radio-frequency identification (RFID) tag. The RFID tag can be an ultra-high frequency (UHF) RFID tag. In some embodiments, the signal device is radially symmetrical and is adapted to be disposed circumferentially about the central longitudinal axis of the body around the central bore. For example, the signal device is ring-shaped. In some embodiments, the signal device is disposed asymmetrically relative to the central longitudinal axis of the body.

In some embodiments, the data storage element of the signal device is both readable and writable. In some embodiments, the signal device is configured to store an operation instruction for the thermal processing torch. The operation instruction can be configured to produce an altered performance characteristic of the thermal processing torch relative to an original performance characteristic produced using the laser nozzle without transferring the operating instruction. The operation instruction can be transferable to the thermal processing system by the data transceiver. In some embodiments, the signal device is spaced at a distance between about 6 inches and about 7 feet from the data transceiver. In some embodiments, the data transceiver is integrated into one of a nozzle changer, an inspection station or a portable reader.

In some embodiments, the signal device includes at least one of a pressure sensor or a strain gauge sensor coupled to or integrated with the nozzle body and configured to detect collision impact in a region of the laser nozzle at which the sensor is located. The pressure sensor can be a piezoelectric sensor configured to measure a pressure in the region so as to detect the collision impact. The strain gauge sensor can be configured to measure deformation or strain in the region so as to detect the collision impact. In some embodiments, the pressure measured by the pressure sensor or the stress value measured by the strain gauge sensor is transmitted to a processor of the laser processing system to detect the collision impact. In some embodiments, the signal device includes a temperature sensor coupled to or integrated with the nozzle body and is configured to measure a temperature in a region of the laser nozzle at which the temperature sensor is located. In some embodiments, the temperature measurements taken by the temperature sensor of the signal device is transmitted to a processor of the laser processing system to detect a loss of cut.

In some embodiments, the thermal regulation component comprises at least one coolant passage located adjacent to at least one surface of the signal device to circulate a flow of a coolant fluid proximate the signal device during the torch operation. The coolant fluid can be one of a liquid or a gas. In some embodiments, the at least one coolant passage is configured to thermally regulate a region of the laser nozzle away from the central longitudinal axis. The thermally regulated region can be radially asymmetrical relative to the central longitudinal axis. In some embodiments, the at least one coolant passage is fluidly separated from the central bore such that the flow of the coolant fluid through the at least one coolant passage is separated from a fluid flow through the central bore in support of the laser beam. In some embodiments, the at least one coolant passage is partially defined by the at least one surface of the signal device to enable direct impingement of the coolant fluid on the at least one surface.

In some embodiments, the at least one coolant passage comprises a plurality of coolant passages forming a cooling manifold disposed between the signal device and the central bore. In some embodiments, the at least one coolant passage includes a plurality of cooling fins disposed into the body of the laser nozzle proximate the signal device, the cooling fins configured to conduct the coolant liquid therethrough to cool the signal device.

In some embodiments, the at least one coolant passage includes at least one inlet for receiving the coolant fluid from the thermal processing torch and at least one outlet for exhausting the coolant fluid from the body of the laser nozzle. In some embodiments, wherein the at least one outlet is located radially opposite from the at least one inlet relative to the central longitudinal axis. In some embodiments, the at least one coolant passage includes a passage configured to receive the coolant fluid from the at least one inlet, direct the coolant fluid to flow circumferentially about the central longitudinal axis, and provide the coolant fluid to the at least one outlet for exhaustion. In some embodiments, the at least one outlet is configured to exhaust the coolant fluid to one of the thermal processing torch or to atmosphere.

In some embodiments, the thermal regulation component comprises a thermally insulating material configured to surround the signal device. At least a portion of the thermally insulating material is disposed between the signal device and a portion of the body of the laser nozzle. In some embodiments, the thermally insulating material comprises a potting compound. In some embodiments, at least a portion of the signal device protrudes from an external surface the body of the laser nozzle and is exposed to an external environment during the torch operation. In some embodiments, the thermal regulation component further includes a shielding element configured to physically block a line-of-sight access between the signal device and the workpiece.

In some embodiments, the thermal regulation component comprises a substantially circumferential channel formed adjacent to the proximal end of the body. The circumferential channel is configured to receive a coolant fluid.

In some embodiments, the laser nozzle further includes a nozzle holder configured to connect the body of the laser nozzle to the thermal processing torch. The nozzle holder can define a set of coolant ports configured to deliver a coolant fluid to the body of the nozzle. In some embodiments, a distal end of the nozzle holder is shaped to complement the proximal end of the body to form an interface that defines a set of coolant flow passages therebetween. The set of coolant ports and coolant flow passages cooperatively provide the coolant fluid proximate the signal device.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 shows an exemplary data communication network architecture of a laser processing system, according to some embodiments of the present invention.

FIG. 2 shows an exemplary configuration of the signal device in association with the laser nozzle of the laser processing system of FIG. 1, according to some embodiments of the present invention.

FIG. 3 shows an exemplary implementation of the laser processing system of FIG. 1 where the transceiver is configured as a portable handheld reader, according to some embodiments of the present invention.

FIG. 4 shows yet another exemplary implementation of the laser processing system of FIG. 1 where the transceiver is configured as a portable handheld reader, according to some embodiments of the present invention.

FIGS. 5a and b show a perspective view and a partial phantom view, respectively, of an exemplary design of the laser nozzle of FIG. 1 for protecting a signal device from thermal exposure during torch operations, according to some embodiments of the present invention.

FIGS. 6a and b show side and perspective partial phantom views of another exemplary design of the laser nozzle of FIG. 1 for protecting a signal device from thermal exposure during torch operations, according to some embodiments of the present invention.

FIGS. 7a-c show perspective and side partial phantom views of another exemplary design of the laser nozzle of FIG. 1 for protecting a signal device from thermal exposure during torch operations, according to some embodiments of the present invention.

FIGS. 8a-d show a side view, a phantom side view, a perspective view and a phantom perspective view, respectively, of another exemplary design of the laser nozzle of FIG. 1 for protecting a signal device from thermal exposure during torch operations, according to some embodiments of the present invention.

FIGS. 9a and 9b show a perspective view and a cross-sectional view, respectively, of another exemplary design of the laser nozzle of FIG. 1 for protecting a signal device from thermal exposure during torch operations, according to some embodiments of the present invention.

FIGS. 10a and b show a perspective view and a cross-sectional view, respectively, of yet another exemplary design of the laser nozzle of FIG. 1 for protecting a signal device from thermal exposure during torch operations, according to some embodiments of the present invention.

FIGS. 11a-c show a perspective view, a cross-sectional view and a partial cutaway end view, respectively, of yet another exemplary design of the laser nozzle of FIG. 1 for protecting a signal device from thermal exposure during torch operations, according to some embodiments of the present invention.

FIG. 12 shows a cross-sectional view of a nozzle holder attached to the laser nozzle of FIG. 1 to protect a signal device in the nozzle from thermal exposure during torch operations, according to some embodiments of the present invention.

FIG. 13 shows an exemplary process for thermally regulating a signal device coupled to or integrated with a body of a laser nozzle in connection with the laser cutting system of FIG. 1 and employing one or more thermal regulation designs of FIGS. 5a-12, according to some embodiments of the present invention.

### DETAILED DESCRIPTION

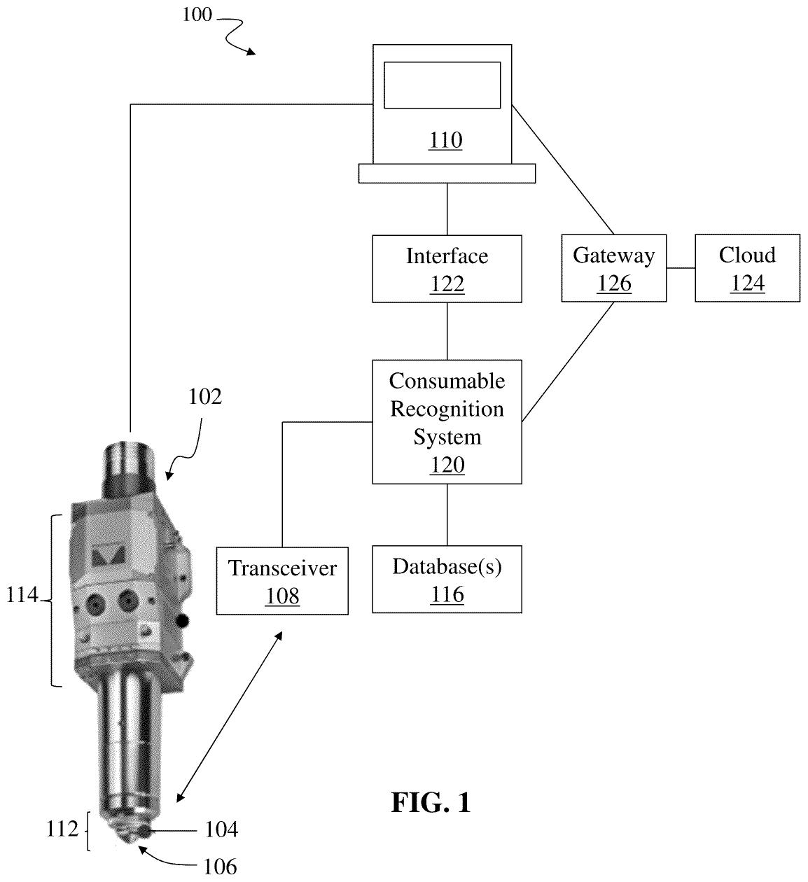

FIG. 1 shows an exemplary data communication network architecture of a laser processing system 100, according to some embodiments of the present invention. Within the laser processing system 100, the communication network provides two-way communication of data between at least one signal device 104 assigned to a consumable 106 (e.g., a laser nozzle) of a laser processing torch 102 and a processor 110 (e.g., a controller). In some embodiments, the processor 110 includes embedded software/hardware modules for controlling the operation of the torch 102 by generating, for example, a suitable cut chart and/or nesting program for operating the torch 102 based on information obtained from the signal device 104. The signal device 104 can be located on (e.g., coupled to) the body of the laser nozzle 106 or embedded within (e.g., integrated with) the body of the laser nozzle 106. The laser nozzle 106 is in turn disposed on the cutting head 112 at the tip of the torch 102. To facilitate communication between the signal device 104 and the processor 110, the communication network further includes at least one transceiver 108 for reading data from the signal device 104 related to the laser nozzle 106 and a consumable recognition system 120 for analyzing data from the transceiver 108 and forwarding the analysis to the processor 110. For example, the consumable recognition system 120 can perform consumable recognition (e.g., recognition of the type of laser nozzle 106 installed on the torch 102) and recommend appropriate system setup parameters/settings for the consumable 106.

In some embodiments, the communication network enables the various components of the laser processing system 100 to communicate with each other wirelessly and/or via wired connections. The network may be a local network, such as a LAN, or a wide area network, such as the Internet and/or a cellular network. In some embodiments, the network is comprised of several discrete networks and/or sub-networks (e.g., cellular to Internet) that enable the components of the laser processing system 100 to communicate with each other.

As described above, the signal device 104 can be coupled to or integrated with the laser nozzle 106 of the torch 102 to store and transmit information about the nozzle 106. Alternatively, the signal device 104 can be coupled to and/or integrated with a torch component adjacent to the nozzle 106, such as a nozzle holder (not shown) connected to the nozzle 106 within the torch tip 112. For example, the nozzle holder can include a communication passage or void for accommodating the signal device 104 and enabling communication with the transceiver 108. Attaching the signal device 104 to the nozzle holder can be advantageous because this arrangement distances the delicate communication means from the tip of the cutting head 112, which is most exposed to the thermal extremes of the cutting process. The signal device 104 attached to the nozzle holder can be encoded with information related to the laser nozzle 106 and/or information related to the nozzle holder. For example, data encoded on the signal device 104 of the nozzle holder can include the life history of the holder along with its process data (e.g., temperature exposures), which can be valuable information in addition to that of the laser nozzle 106. In some embodiments, the nozzle 106 and the nozzle holder are assembled as a coupled pair with common and/or distinct signal devices 104.

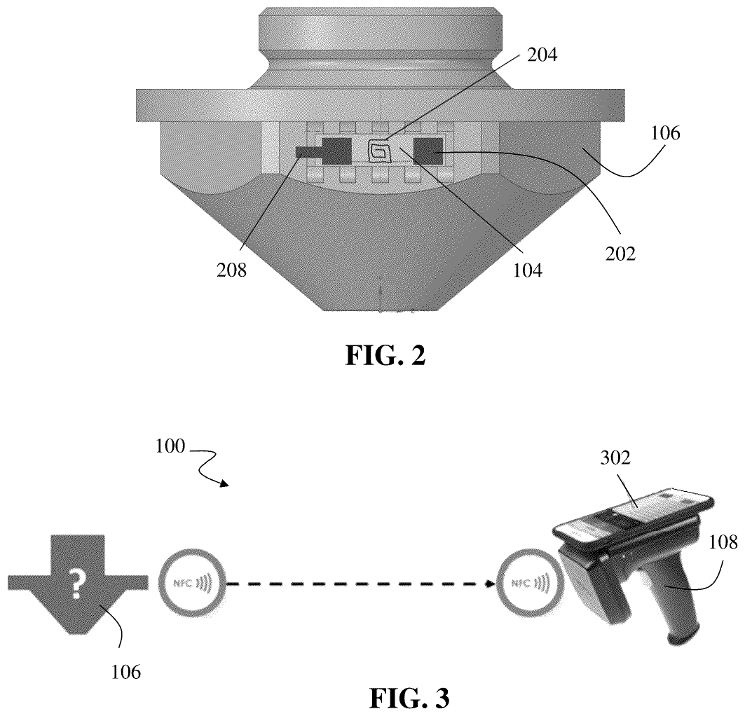

FIG. 2 shows an exemplary configuration of the signal device 104 in association with the laser nozzle 106 of the laser processing system 100 of FIG. 1, according to some embodiments of the present invention. As shown, the signal device 104 includes a data storage element 202 (e.g., an integrated circuit chip) for storing data. The signal device 104 can also include an antenna 204 for transmitting data to and/or receiving data from the data storage element 202. The combination of the antenna 204 and the data storage element 202 can form a data tag, such as a radio-frequency identification (RFID) tag (e.g., an ultra-high frequency (UHF) RFID tag). The data storage element 202 can be both readable and writable. In some embodiments, the data storage element 202 is rewritable, such that it can record new data after the initial writing of data (e.g., with or without deleting other data present on the data storage element 202). As an example, the data storage element 202 can be rewritable while outside of the torch 102 (e.g., during service of the torch 102 or the consumable 106 recording dimensional CTFs, quality inspection data, etc.) or while being disposed within the torch 102 (e.g., during use of the torch 102 recording temperature data, motion data, etc.). In some embodiments, the signal device 104 includes a detector 208 for detecting a physical characteristic of the corresponding consumable 106 and transmitting the detected information in the form of one or more electrical signals via the antenna 204 of the signal device 104. The detector 208 can comprise mechanical features (e.g., passages, faces, critical orifice(s), appendage, whisker, features that deflect, features that conduct heat, current, capacitance, etc.) for enabling sensing of process parameters, such as a sensor. For example, the detector 208 can be a temperature sensor for measuring the surrounding temperature, an accelerometer for measuring acceleration or rapid deceleration of the assigned consumable during motion that is usable to provide feedback for component wear if any oscillations and/or collisions were detected, a gas flow meter for detecting the flow rate of one or more cutting gases, a pressure sensor for detecting impact, etc. Details regarding the detector 208 of the signal device 104 are provided below.

In the embodiment of FIG. 2, the signal device 104 includes the antenna 204, along with both the data storage element 202, such as an IC chip, for storing consumable data and at least one detector 208, such as a sensor, for measuring consumable physical characteristics. This design enhances the functionality and reliability of the assigned consumable 106 (e.g., the laser cutting nozzle) by providing continuous monitoring of critical parameters. The integration of the data storage element 202, the detector 208, and the antenna 204 within the signal device 104 allows for efficient data collection and transmission as well as facilitates better control and maintenance of the laser cutting process. Alternatively, the signal device 104 can include the antenna 204 with only one of the data storage element 202 or the detector 208. In some embodiments, the signal device 104 includes multiple detectors 208 to measure different physical characteristics of the assigned consumable 108. In some embodiments, the signal device 104 includes multiple data storage elements 202 that store different types of data. In general, these components 202, 208 can serve different functionalities, such as encryption, sensing, data storage, etc. In some embodiments, the detector 208 and/or the data storage element 202 can communicate wirelessly at a distance with the antenna 204 via a tuned signal path. For example, the antenna 204 can be positioned about 1 foot away from the data storage element 202 and/or the detector 208.

In some embodiments, the data storage element 202 of the signal device 104 is encoded with information pertaining to the consumable 106 (e.g., the laser nozzle) to which the signal device 104 is assigned, and the information is transferable to the consumable recognition system 120 and/or the processor 110 by the transceiver 108 via the antenna 204 of the signal device 104. For example, if the consumable 106 is the laser nozzle of the laser processing torch 102, the encoded data can be one or more of a part number, a unique identifier that corresponds to one or more unique elements, or a unique cut parameter combination that corresponds to the unique identifier associated with the laser nozzle 106. Encoded data can also include ranges and settings for operating the torch 102 that are compatible with the particular laser nozzle 106 installed, such as data related to one or more of power, gas type and flow, focal position, stand-off, cut speed, acceleration/deceleration profiles, angle to workpiece, manufacturing data, trademarks, anti-counterfeit signature, customizable data associated with other corporate entities, etc. In some embodiments, the encoded data comprises factory inspection and quality assurance data associated with the laser nozzle 106 such that the data can be interrogated later if an issue arises with the laser nozzle 106. Exemplary factory inspection and quality assurance data includes dimensional CTFs and physical attributes, nozzle data, assembly information, in-situ tests, etc. In some embodiments, the encoded data comprises an operation instruction for the torch 102. The operation instruction is adapted to produce an altered performance characteristic of the torch 102 relative to an original performance characteristic produced by the torch 102 using the laser nozzle 106 without the operating instruction. One such encoded instruction can comprise limiting the focal position location and/or beam mode to closely match the nozzle diameter without allowing excessive clipping. In some embodiments, laser beam settings/conditions such as gas pressure, flow, composition etc. are adjusted based on data obtained from laser nozzle 106 via data storage element 202, which indicate a degree of wear, thermal load exposure, and/or reduced life on laser nozzle 106. In some embodiments, torch motions and/or accelerations etc. are adjusted based on data obtained from laser nozzle 106 via data storage element 202, which indicate a degree of wear, thermal load exposure and/or reduced life on laser nozzle 106.

In some embodiments, the at least one detector 208 of the signal device 104 can be a sensor that is configured to emit electrical signals transmittable to the consumable recognition system 120 and/or the processor 110 via the antenna 204 of the signal device 104. In some embodiments, the detector 208 is a pressure sensor used to detect collision impacts at or adjacent to the consumable 106 to which the sensor 208 is attached. The pressure sensor 208 can be a piezoelectric sensor configured to measure the pressure surrounding the sensor 208, which can be effectively utilized to detect and measure collision impacts. Specifically, piezoelectric materials of the sensor 208, such as polyvinylidene fluoride (PVDF), are adapted to generate an electrical charge when subjected to mechanical stress or vibration, making them suitable for impact detection. In some embodiments, the pressure sensor 208, which is adapted to produce voltage signals upon impact, can be attached to any one of the laser nozzle 106, the laser nozzle holder, or the workpiece. The signals emitted by the pressure sensor 208 can be processed and analyzed for impact/collision occurrences. For example, the amplitude and frequency of the signals can provide information about the impact force and collision characteristics. Real-time continuous monitoring of the sensor output permits detection of collisions in real-time. This can be useful for ensuring the quality of the laser cutting process and preventing damage to the equipment or workpiece. In addition, data collected from the pressure sensor 208 can be analyzed to understand impact dynamics, such as force distribution and/or frequency of collisions. This information can be used to optimize the quality of the laser cutting process and improve safety.

In some embodiments, the detector 208 of the signal device 104 is a strain gauge sensor for measuring an impact force on the region of the torch 102 at which the sensor 208 is located. For example, the strain gauge sensor 208 can be attached to the nozzle holder (or the nozzle 106) at specific locations where deformation is expected during impact with an object (e.g., with the workpiece) to detect deformation or strain on the laser nozzle 106 and/or the laser nozzle holder due to the impact. This detection can be accomplished by the strain gauge sensor 208 measuring the amount of deformation/strain on the laser nozzle 106 and/or the nozzle holder upon impact by generating an electrical signal proportional to the strain. The resulting electrical signals from the strain gauge sensor 208 are amplified and processed by the consumable recognition system 120 and/or the processor 110, which can convert the signals into readable data, such as force or stress values that are used to assess collision dynamics and ensure that the laser cutting process is within safety limits. In general, the strain gauge sensor 208 can accurately measure impact forces, which in turn allows the laser processing system 100 to make the necessary adjustments to improve cutting processes and prevent damage to the equipment or workpiece.

In some embodiments, the detector 208 of the signal device 104 is a temperature sensor for measuring the temperature proximate the location of the torch 102 where the sensor 208 is placed. For example, the temperature sensor 208 can be attached to the laser nozzle 106 or the nozzle holder. The temperature readings by the temperature sensor 208 can be processed by the consumable recognition system 120 and/or the processor 110 for monitoring the temperature of the consumable 106 to which it is attached (e.g., the laser nozzle). Such temperature monitoring can be used to detect a loss of cut, determine and/or predict a degree of wear and remaining life for consumable 106, predicting a fitness to continue laser processing operations for consumable 106, etc. For example, when a cut is lost the rate of temperature rise increases, detection of which allows the processor 110 to take appropriate and timely action(s), such as alerting an operator or shutting down the laser processing system 100.

Referring back to FIG. 1, the transceiver 108 of the laser processing system 100 is configured to (i) receive signals transmitted by the antenna 204 of the signal device 104 (either wirelessly or via a wire connected between the transceiver 108 and the antenna 204), (ii) extract the encoded data conveyed by the signals, and (iii) transmit the extracted data to the consumable recognition system 120 and/or the processor 110 (either wirelessly or via wired communication) for analysis and further action. In some embodiments, in addition to reading data from the signal device 104, the transceiver 204 is also a data writing device configured to write to the rewritable data storage element 202 of the signal device 104 positioned within the torch 102. The transceiver 108 can be located at a distance from the signal device 104, such as on or within the torch 102 (e.g., on the torch body 114 away from the cutting head 112) or external to the torch 102 entirely. For example, the transceiver 108 can be spaced at a distance between about 6 inches and about 7 feet from the signal device 104, such as great than about 1 foot away from the signal device 104.

In some embodiments, upon receiving the consumable data encoded in the signal device 104 and transmitted by the transceiver 108, the consumable recognition system 120 of the laser processing system 100 is configured to set processing parameters for the laser processing torch 102, such as cutting speed, assist gas type and pressure, focal position, laser power, etc., where these parameters are optimized based on the consumable data obtained from the signal device 104. In some embodiments, the consumable recognition system 120 generates the identification information and the system setup recommendations using, at least in part, additional data stored in a set of one or more databases 116, including a cutting parameter database and a history database in electrical communication with the processor 110 and/or the consumable recognition system 120. The cutting database 116 can be configured to store the recommended parameters for the nozzle 106 and the history database 116 can be configured to store the “life story” of the particular nozzle 106 in use, including events that can potentially degrade performance. In conjunction with the stored data from the signal device 104, the consumable recognition system 120 can use information from both databases 116 (e.g., history and cutting databases) to modify the recommended parameter settings for the nozzle 106 to improve cutting, such as reduce speed or change pressure. In some embodiments, data conveyed by the signal device 104 and received by the consumable recognition system 120 can be stored in one or more of the databases 116 for consumable usage tracking and other future references. The databases 116 can also store analysis data generated by the consumable recognition system 120 and/or the processor 110. In some embodiments, the consumable recognition system 120 includes a combination of software and hardware, such as a specialized set of computer software instructions programmed onto a dedicated processor and can include specifically designated memory locations and/or registers for executing the specialized computer software instructions.

In some embodiments, all or a portion of the set of databases 116 is integrated with the signal device 104 (such as stored in the data storage element of the signal device 104), the processor 110 and/or the consumable recognition system 120, or located on a separate, stand-alone computing device or devices (not shown). In some embodiments, all or a portion of the set of databases 116 is stored in an Internet-based cloud storage location 124 that allows components of the laser processing system 100 to access the data on demand without locally maintaining storage infrastructure(s). The cloud storage location 124 can connect to the communication network of the laser processing system 100 via a cloud gateway 126, which can be a hardware device, a software application or a combination thereof. In some embodiments, data used and/or generated by the processor 110 and/or the consumable recognition system 120 can be stored in the cloud storage location 124 via the cloud gateway 126.

The consumable recognition system 120 can be further configured to convey the consumable recognition information and the system setup recommendations to the processor 110, based on which the processor 110 can customize torch operations and setup in a feedback loop. In some embodiments, an interface 122 is provided between the consumable recognition system 120 and the processor 110 to facilitate communication between the two components. The interface 122 can comprise an application programming interface (API) for integration of the consumable recognition system 120 with the software of the processor 110 and/or a configurable fieldbus to facilitate data and controls communications of the consumable recognition system 120 with the processor 110. In some embodiments, one or more portions of the consumable recognition system 120 are integrated with the processor 110 or vice versa.

In some embodiments, the processor 110 of the laser processing system 100 is configured to control and optimize the operation of the laser processing torch 102 relative to a workpiece (not shown) based on the consumable recognition information and the system setup recommendations from the consumable recognition system 120. The processor 110 can customize many system functions that include, but not limited to, start sequence, CNC interface functions, gas and operating parameters, and shut off sequences. For example, based on the information received from the consumable recognition system 120, the processor 110 can customize for the laser processing torch 102 (i) a cut chart that provides a specific combination of recommended settings for a suite of one or more operating parameters to perform a desired torch operation (e.g., cut a sequence of parts from the workpiece), and/or (ii) a nesting program that provides a specific sequence of torch operations. In some embodiments, the processor 110 executes one or more artificial intelligence (AI) routines that log live process issues such as collisions and loss of cut data and use the data in a feedback loop to adjust the parameters from the nesting program for reducing these errors. In some embodiments, the processor 110, based on the laser nozzle identified by the consumable recognition system 120, enables automated delivery of cut recipes for operating the torch 102 that is optimized to the laser nozzle 106, insures that the cutting system 100 only proceeds with a cutting program if the correct nozzle has been loaded onto the cutting head 112, prevents loading of a damaged nozzle (e.g., automated poka-yoke), allows for automatic reordering of consumables based on a discreet condition, provides the ability to remotely update and modify cut formulas and recipes for a specific nozzle/condition identified, and/or alert an operator to a damaged, degraded, and/or compromised nozzle. In some embodiments, the processor 110 is a digital signal processor (DSP), microprocessor, microcontroller, computer, computer numeric controller (CNC) machine tool, programmable logic controller (PLC), application-specific integrated circuit (ASIC), or the like.

In an exemplary implementation of the communication network of the laser processing system 100, the communication network can be configured to precisely and accurately identify the laser nozzle 106 installed on the laser processing torch 102 using the signal device 104. The identification information can then be leveraged by the laser processing system 100 to estimate, monitor and track gas consumption of the laser processing system 100 during torch operations without utilizing any physical gas flow meters. First, the consumable identification system 120 can identify what nozzle 106 is installed in the cutting head 112 of the laser processing torch 102 when performing a given operation based on data stored in the signal device 104 (which can comprise an RFID tag). Then during the same operation, the consumable identification system 120 and/or the processor 110 can continuously or periodically record both gas pressure supplied to the nozzle 106 (e.g., standard process settings) and cut height of the laser nozzle 106 relative to the workpiece (e.g., backpressure generated from gas flowing out the distal end of the nozzle 106 and hitting the workpiece and pushing back). Utilizing the identification information, combined with the gas pressure and cut height information, the processor 110 can estimate gas consumption during torch cutting. For example, the processor 110 can first find the correct lookup calibration table for the identified nozzle type from a library of lookup calibration tables, where each table correlates a kind/model number of laser nozzle with the theoretical gas consumption of the laser nozzle operated at different cut heights and gas pressures. Then, for the correct lookup calibration table identified, the processor 110 can use the cut height and gas pressure data to find a good estimate of gas consumption. In some embodiments, with the gas pressures, flow rates, back pressures, durations, pressure drops and cross-sectional areas of the nozzle gas flow passages all known, the gas consumption/usage can be accurately determined and/or estimated. Consumption estimates can include, but are not limited to, gas consumption “speedometer” in real time as well as a sum of gas consumption over the feature/part/nest “mileage trip odometer” to obtain a total gas usage of the laser processing system 100. This gas consumption monitoring approach is advantageous because it obviates the need to install a physical network of expensive and complicated gas flow meters as a part of the gas delivery system to monitor gas pressures and flow rates.

In some embodiments, in addition to or in place of the signal device 104 located on the torch 102, the thermal processing system 100 includes at least one sensing device (not shown) external to the torch 102 for measuring/sensing certain physical characteristics of the torch 102 in-situ. The external sensing device can be configured to communicate with and/or obtain data from at least one torch consumable 106 (e.g., the laser nozzle) and convey the data to the consumable recognition system 120 and/or the processor 110 for processing and analysis. The external sensing device can comprise, for example, one or more of ultrasonic means, an infrared camera, a strain gauge sensor, a chip-based sensor that reads impedance, a humidity sensor, a vision inspection camera; etc. The resulting measurements taken can include, for example, gas flow/pressure/type, kilowatts/power, speed, focal position, stand-off, speed/acceleration/deceleration, physical and digital attributes, manufacturing, and quality assurance metrics (e.g., dimensional CTFs, finish, tag test and/or other specifications). In some embodiments, the measurements can be stored in one or more of the databases 116 (e.g., the history database) for future reference/tracking.

In some embodiments, the communication network includes fault detection logics (not shown) for detecting faults in the laser processing system 100 based on the data obtained from the signal device 104 and/or analysis of data performed by the consumable recognition system 120 and/or the processor 110. The fault detection program is adapted to detect mistakes such as oxidization, poor cut quality, collisions and tip touches, beam misalignment, etc. In some embodiments, the communication network includes logics for confirming that a torch consumable 106, such as the laser nozzle, is in a specific location at a specific time, such as installed on the torch head 112 while cutting, in a particular location of a nozzle changer (not shown), in a particular inventory location, at an automated tool crib/tool boss (not shown), in an original quality-assurance/quality-control step at the original equipment manufacturer (OEM), etc. The fault detection logics and/or the consumable confirmation logics can be programmed into one or more hardware components of the laser processing system 100 and/or one or more software components of the laser processing system 100, such as in the consumable recognition system 120 and/or the processor 110.

FIG. 3 shows an exemplary implementation of the laser processing system 100 of FIG. 1 where the transceiver 108 is configured as a portable handheld reader, according to some embodiments of the present invention. The laser nozzle 106 is associated with the signal device 104, which comprises an UHF RFID tag, integrated with or coupled to the body of the nozzle 106. The UHF handheld reader 108 is configured to access/read data stored in the UHF RFID tag of the signal device 104 at a convenient location, such as while the laser nozzle 106 is in the field, and/or at a convenient time, such as when the laser nozzle 106 is offline (i.e., not being used inside of a torch). The reader 108 can wirelessly communicate with the consumable recognition system 120 and/or the processor 110 to identify an attribute associated with the laser nozzle 106 and the attribute can be displayed on a graphical user interface 302 of the reader 108. Exemplary attributes include, but are not limited to, nozzle type, part number, history of usage of the laser nozzle 106 and/or whether it is time to replace the laser nozzle 106 and/or the nozzle holder.

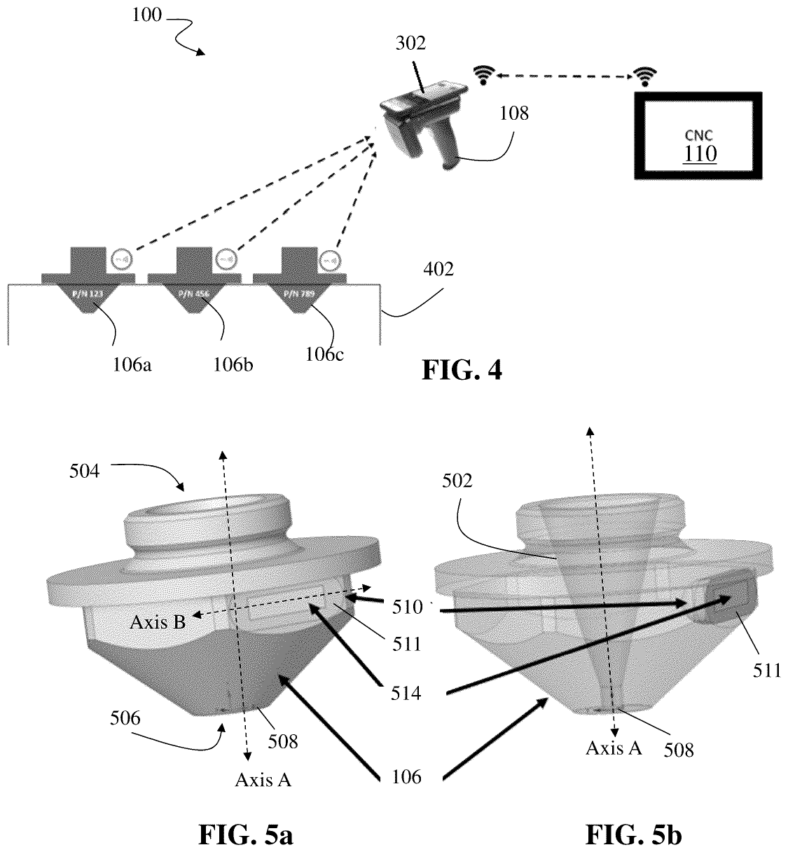

FIG. 4 shows yet another exemplary implementation of the laser processing system 100 of FIG. 1 where the transceiver 108 is configured as a portable handheld reader, according to some embodiments of the present invention. As shown, the system 100 includes an array of multiple laser nozzles 106a-c with their respective signal devices 104a-c coupled or integrated thereto. The laser nozzles 106a-c are located offline in a nozzle changer 402. A single transceiver 108, which is configured as a handheld reader, can perform offline reading of the signal devices 104a-c to extract attributes associated with corresponding ones of the laser nozzles 106a-c. The handheld reader 108 can also transmit the attribute information to the consumable recognition system 120 and/or the processor 110 for planning, analysis, operations, etc. For example, the transceiver 108 can facilitate communication between the signal devices 104a-c and the consumable recognition system 120 and/or the processor 110 to determine nozzle type, nozzle usage history, cutting operation information associated with the nozzles (e.g., nest selection, cut chart selection, etc.), as well as identify and confirm the specific locations of the nozzles 106a-c in the nozzle changer 402 using the fault detection logics described above. Such information can be displayed to the user via the graphical user interface 302 of the reader 108.

As shown in FIGS. 3 and 4, the transceiver 108, which is in the form of a handheld reader, represents a portable stand-alone component in the laser processing system 100 for reading data stored on one or more signal devices 104. Alternatively, the transceiver 108 can be attached to or integrated with the cutting head 112 of the torch 102 in proximity to the nozzle 106 and/or the nozzle holder when they are installed on the torch 102, thereby maintaining a relatively short communication distance with the laser nozzle 106 and/or the nozzle holder during torch cutting operations. In some embodiments, the transceiver 108 is attached to or integrated with the nozzle holder. In some embodiments, the transceiver 108 is attached to or integrated with the nozzle changer 402 or another component of the laser process system 100 external to the torch 102, such as with an inspection station (not shown). In some embodiments, each signal device 104 includes an RFID tag and the transceiver 108 additionally functions as an RFID writer configured to write to the signal device 104 based on data received from the processor 110. As an example, integration of a read/write RFID system with processor communication at an inspection station can greatly improve the accuracy, function, and operation of the laser processing system 100.

In another aspect, the laser nozzle 106 of the laser processing torch 102 can be designed to include one or more physical features for protecting the signal device 104 coupled to or integrated with the body of the laser nozzle, such as from the extreme thermal loads (e.g., very high temperatures) generated during laser processing operations. This is because thermal loads experienced by laser nozzles during torch operations pose significant challenges to the life and operation of communication devices associated with these laser nozzles. Embodiments of the present invention thus include one or more thermal regulation, insulation, and protective means configured to insulate and/or shield the signal device 104 from exposure to the extreme temperatures and debris created by operations of industrial cutting laser torches.

In some embodiments, the laser nozzle 106 of the present invention includes a thermal regulation component coupled to or integrated with the body of the laser nozzle 106 or the laser holder. The thermal regulation component can be located adjacent to the signal device 104 to provide cooling to one or more components of the signal device 104 (e.g., the data storage element 202, the antenna 204 and/or the detector 208) during a torch operation, thereby enabling data stored in the data storage element 202 and/or signal transmitted by the detector 208 to be readable by the data transceiver 108 during torch operation when a large heat load is typically present. In some embodiments, the thermal regulation component is a recess within which the signal device 104 is located or a metallic shield that deflects molten material (such as a flange or protrusion), thereby physically guarding the signal device 104. In some other embodiments, the thermal regulation component is a separate mounting device of the nozzle 106 or the nozzle holder that includes one or more of cooling channels or surfaces, insulating features (e.g., a heat shield), isolation features from the metallic nozzle body, active cooling features communicating from the nozzle holder, active cooling via direct impingement on the signal device 104 or adjacent channels, and/or gas or liquid cooling. In some embodiments, where the signal device 104 is mounted onto the nozzle via an insulator, such as an insulating mounting device, the flow passage(s) from the nozzle plenum to the signal device 104 serves as a double nozzle, such that the flow passage(s) draw off some gas flow from the central bore to thermally regulate/cool the signal device 104. Details and examples regarding thermal regulation of the laser nozzle 106, including the signal device 104, are provided below.

FIGS. 5a and b show a perspective view and a partial phantom view, respectively, of an exemplary design of the laser nozzle 106 of FIG. 1 for protecting a signal device 514 from thermal exposure during torch operations, according to some embodiments of the present invention. As shown, the laser nozzle 106 includes a body defining a central bore 502 extending along a central longitudinal axis A of the body from the proximal end 504 to the distal end 506 of the body. The distal end 506 is defined as the end of the nozzle body that is closest to the workpiece (not shown) during torch operation and the proximal end 504 is opposite of the distal end 506 along the longitudinal axis A. The central bore 502 has an exit orifice 508 and is configured to conduct a laser beam to a workpiece via the exit orifice 508 to process the workpiece in a laser processing operation. In some embodiments, the laser beam produces at least about 2,000 Watts of power when used to process the workpiece. In some embodiments, the laser beam produces at least about 6,000 Watts of power when used to process the workpiece.

A signal device 514, which comprises the same characteristics as the signal device 104 described above in detail with reference to FIGS. 1 and 2, can be coupled to or integrated with the body of the laser nozzle 106. In the embodiment of FIGS. 5a and b, the signal device 514 is substantially cuboid in shape and defines a central longitudinal axis B. Upon assembly, the signal device 514 can be disposed asymmetrically relative to the central longitudinal axis A of the nozzle body. In particular, the central longitudinal axis B of the signal device 514 can be positioned normal/perpendicular to longitudinal axis A of the nozzle body. In alternative embodiments, the central longitudinal axis B of the signal device 514 can be oriented coaxial with but offset from the longitudinal axis A of the nozzle 106 when coupled to (or integrated with) the nozzle body.

A thermal regulation component 510 can also be coupled to or integrated with the body of the laser nozzle 106 to provide insulation and/or cooling to the asymmetrical cuboid-shaped signal device 514. The thermal regulation component 510 can be a region filled with a thermally insulating material (e.g. a potting compound) 511 that physically contacts at least a portion of the signal device 514. The thermally insulating material 511 can be disposed between the signal device 514 and a portion of the body of the laser nozzle 106 to provide thermal regulation to the signal device 514. As an example, the thermal regulation component 510 can be an encasement around the signal device 514, where the encasement is filled with the thermally insulating material 511 that surrounds at least a portion of the signal device 514 disposed therein. The encasement can be such that at least a portion of which protrudes from an external surface of the body of the laser nozzle 106 and is exposed to an external environment during the torch operation. Alternatively, the encasement can be recessed within the body of the laser nozzle 106 to prevent the signal device 514 from external exposure.

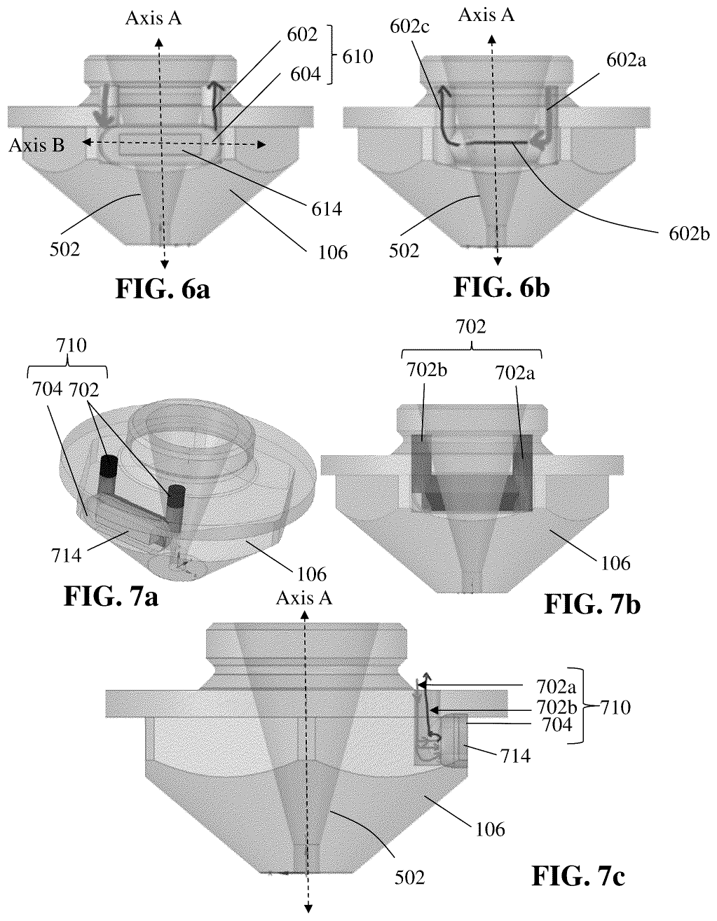

FIGS. 6a and b show side and perspective partial phantom views of another exemplary design of the laser nozzle 106 of FIG. 1 for protecting a signal device 614 from thermal exposure during torch operations, according to some embodiments of the present invention. FIG. 6a shows the nozzle design having the signal device 614 coupled or integrated thereto, while FIG. 6b shows the same design without the signal device 614 to better visualize a thermal regulation component 610 for providing thermal protection to the signal device 614. The signal device 614 can be substantially the same as the asymmetric cuboid-shaped signal device 514 of FIGS. 5a and b. The nozzle body can be substantially the same as the nozzle body of FIGS. 5a and 5b.

The thermal regulation component 610 of FIGS. 6a and b can be substantially the same as the thermal regulation component 510 of FIGS. 5a and b (e.g., having a region filled with a thermally insulating material 604 in physical contact with at least a portion of the signal device 614), with the addition of an active localized cooling element in the form of a set of one or more coolant passages 602. The set of one or more coolant passages 602 can be located adjacent to at least one surface of the signal device 614 to circulate a flow of a coolant fluid proximate the signal device 614 during torch operations. For example, the one or more coolant passages 602 can be embedded in the thermally isolating material 604 of the thermal regulation component 610 and either physically contacting the signal device 614 to provide direct cooling or close to the signal device 614 to provide indirect cooling. The coolant fluid conducted through the coolant passages 602 can be one of a liquid or a gas. In alternative embodiments, the thermal regulation component 610 includes only the set of coolant passages 602 without the thermally insulating material 604.

As shown in FIGS. 6a and b, the set of coolant passages 602 is located behind the signal device 614, i.e., between the signal device 614 and the nozzle body (central longitudinal axis A and/or the laser beam). The set of coolant passages 602 can include an axial inlet segment 602a (parallel to the central longitudinal axis A of the nozzle body) configured to conduct the coolant fluid toward the signal device 614, a radial segment 602b configured to conduct the coolant fluid along the longitudinal axis B of the body of the signal device 614 (e.g., at or proximate a surface of the signal device 614), and an axial outlet segment 602c configured to conduct the heated coolant fluid away from the signal device 614 to eventually exit from the laser nozzle 106. In the case of direct cooling, the radial coolant passage 602b can be partially defined by at least one surface of the signal device 614 to enable direct impingement of the coolant fluid on that surface. Because the set of coolant passages 602 are localized to the signal device 614, which is radially asymmetric relative to the central longitudinal axis A of the nozzle body and located away from the central longitudinal axis A, the region that is thermally regulated by the coolant passages 602 is also radially asymmetric relative to and away from the central longitudinal axis A. In some embodiments, the set of coolant passages 602 is fluidly separated from the central bore 502 of the laser nozzle 106 such that the flow of the coolant fluid through the coolant passages 602 is separated from the fluid flow through the central bore 502 in support of the laser beam.

FIGS. 7a-c show perspective and side partial phantom views of another exemplary design of the laser nozzle 106 of FIG. 1 for protecting a signal device 714 from thermal exposure during torch operations, according to some embodiments of the present invention. FIG. 7a shows the nozzle design having the signal device 714 coupled or integrated thereto, while FIG. 7b shows the same design without the signal device 714 to better visualize a thermal regulation component 710 for providing thermal protection to the signal device 714, and FIG. 7c shows a profile view of the design of FIG. 7a. The signal device 714 can be substantially the same as the asymmetric cuboid-shaped signal device 514 of FIGS. 5a and b. The nozzle body can be substantially the same as the nozzle body of FIGS. 5a and 5b.

The thermal regulation component 710 of FIGS. 7a-c can be substantially the same as the thermal regulation component 510 of FIGS. 5a and b (e.g., having a region filled with a thermally insulating material 704 in physical contact with at least a portion of the signal device 714), with the addition of an active localized cooling element in the form of a cooling manifold 702. The cooling manifold 702 can be coupled to or integrated with the body of the laser nozzle 106. As shown in FIG. 7c, the thermally insulating material 704 can be located on the proximal and distal surfaces of the signal device 714, while the cooling manifold 702 can be located behind the signal device 714 and in physical communication with a side surface of the signal device 714 to provide impinged cooling on the side surface of the signal device 714. Thus, the cooling manifold 702 is disposed between the signal device 714 and the central bore 502 of the laser nozzle 106. In some embodiments, the cooling manifold 702 can be situated such that it provides impinged cooling on multiple surfaces of the signal device 714. As shown in FIGS. 7b and 7c, the cooling manifold 702 includes two passages 702a and b, where passage 702a is configured to introduce the coolant fluid toward the signal device 714 to cool the signal device 714, while passage 702b is configured to conduct the resulting warm coolant fluid away from the signal device 714. In some embodiments, as shown in FIG. 7c, passage 702a is configured a meandering/squiggly flow pattern to promote high velocity flow that enhances heat transfer. In addition, as shown in the embodiment of FIG. 7c, passages 702a and 702b combine to form a substantially serpentine coolant flow pattern within laser nozzle 106 between central longitudinal axis A (e.g., the laser beam) and the signal device 714, with the coolant flow first being delivered axially distal in the coolant passages and progressively working rearwards toward the proximal end of laser nozzle 106.

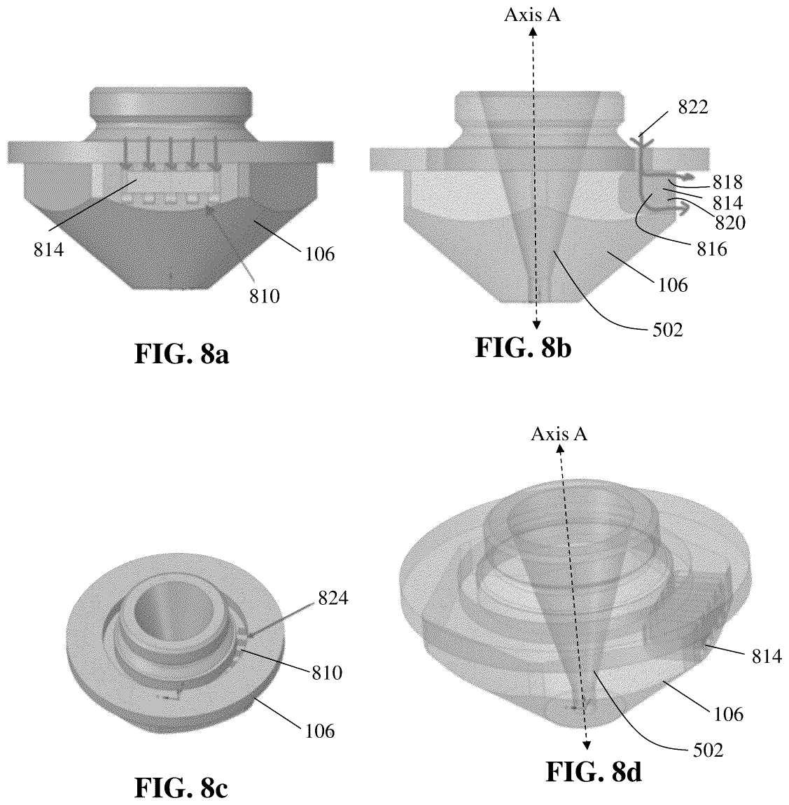

FIGS. 8a-d show a side view, a phantom side view, a perspective view and a phantom perspective view, respectively, of another exemplary design of the laser nozzle 106 of FIG. 1 for protecting a signal device 814 from thermal exposure during torch operations, according to some embodiments of the present invention. The signal device 814 can be substantially the same as the asymmetric cuboid-shaped signal device 514 of FIGS. 5a and b. The nozzle body can be substantially the same as the nozzle body of FIGS. 5a and 5b.

The design of FIGS. 8a-d includes a thermal regulation component 810 in the form of a set of one or more cooling fins disposed into (e.g., etched into, machined into, additively manufactured into, etc.) the body of the laser nozzle 106 proximate the signal device 814. The cooling fins 810 form passages that are configured to conduct a coolant fluid therethrough to cool the signal device 814, to stand off signal device 814 from Axis A/distance signal device 814 from the thermal heat source, and/or to increase active cooling of the laser nozzle 106 features (e.g., cooling fins 810) directly supporting the signal device 814. As shown in FIGS. 8a and b, the set of cooling fins 810 form a recess to receive the signal device 814 such that the passages formed by the fins 810 are in direct communication with multiple surfaces of the signal device 814 to provide impinged cooling on these surfaces. In particular, as shown in FIG. 8b, the fins 810 generate a cooling path 822 that conducts the coolant fluid along a side surface 816 of the signal device 814 as well as along proximal and distal surfaces 818, 820 of the signal device 814 to provide simultaneous thermal regulation of the multiple surfaces during a cutting operation.

As shown in FIGS. 8c and d, the coolant fluid enters the fins 810 via inlets 824 of the respective passages formed by the fins 810. The coolant fluid is adapted to travel across and thermally regulate the fins 810 via these passages disposed substantially about and proximate the signal device 814, such as over surfaces 816, 818 and 820 of the signal device 814, before exiting from the side of the nozzle 106 via an outlet (not shown), which can be configured as a vent from the side of the nozzle 106 that allows the warmed coolant fluid to exit to the ambient environment. In general, the presence and location of the fins 810 about the signal device 814 are adapted to increase the signal device's surface area exposure to coolant flow and thus increase cooling experienced by the signal device 104, thereby insulating it from the extreme thermal loads of the laser nozzle 106 during torch operations.

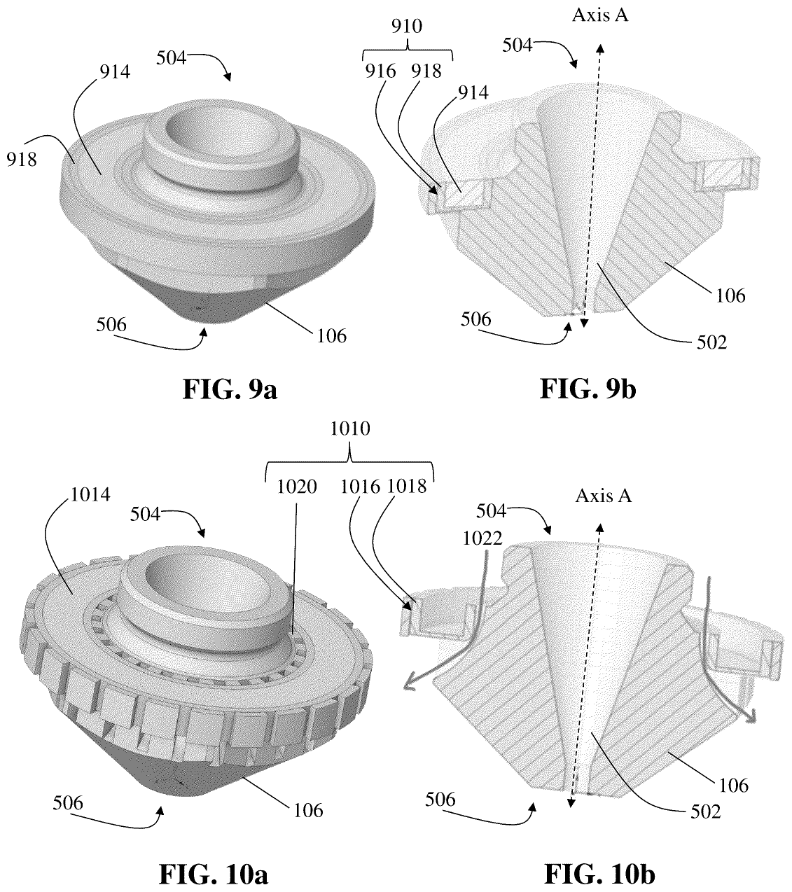

FIGS. 9a and 9b show a perspective view and a cross-sectional view, respectively, of another exemplary design of the laser nozzle 106 of FIG. 1 for protecting a signal device 914 from thermal exposure during torch operations, according to some embodiments of the present invention. The laser nozzle 106 can be substantially similar to the nozzle of FIGS. 5a and b. The signal device 914, including components described above in detail with reference to FIG. 2 (e.g., antenna 203, data storage device 202 and/or detector 208), can be coupled to the body or integrated with the body of the laser nozzle 106. In the embodiment of FIGS. 9a and b, the signal device 914 is circular/ring shaped. Upon assembly, the signal device 914 is disposed radially symmetrical (i.e., circumferential) about the central longitudinal axis A of the nozzle body around the central bore 502.

As shown, a thermal regulation component 910 can be coupled to the body or integrated with the body of the laser nozzle 106 to provide thermal isolation of the symmetrical ring-shaped signal device 914. Specifically, the thermal regulation component 910 can be a circular channel 916 filled with a thermally insulating material (e.g. a potting compound) 918 within which the signal device 914 is disposed. The thermally insulating material 918 can surround and physically contact one or more surfaces of the signal device 914 within the channel 916 to provide thermal regulation and/or insulation to the signal device 914 therein. As an example, the thermal regulation component 910 can be an encasement around the signal device 914, where the encasement is filled with the thermally insulating material 918 that surrounds the signal device 914 on multiple sides. In some embodiments, the thermal regulation component 910, along with the signal device 914, is located adjacent to the proximal end 504 of the laser nozzle 106 to be distanced from the cutting process and insulated by both the nozzle 106 itself and the insulating material 918.

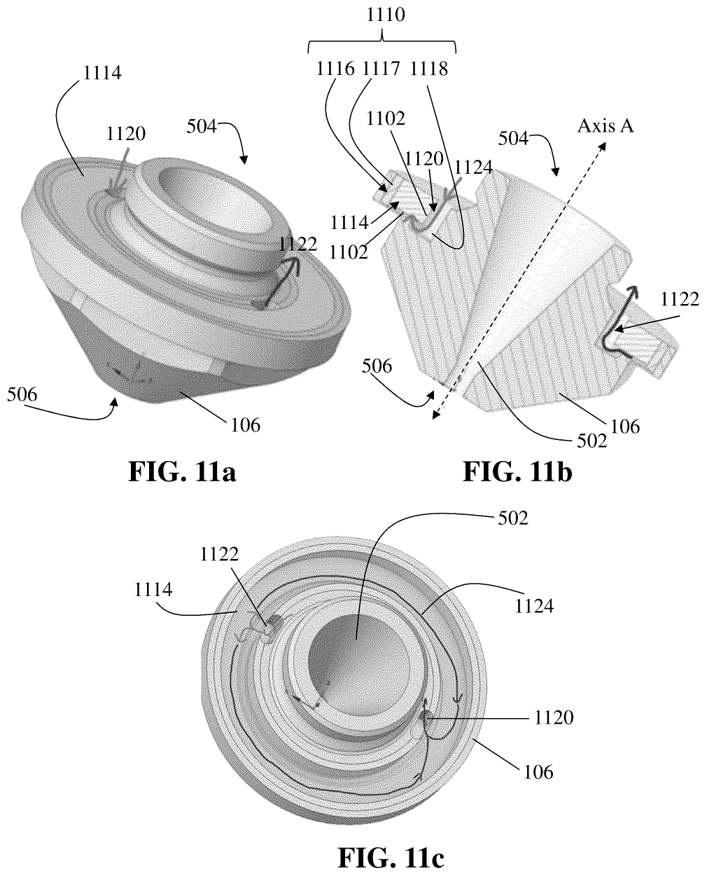

FIGS. 10a and b show a perspective view and a cross-sectional view, respectively, of yet another exemplary design of the laser nozzle 106 of FIG. 1 for protecting a signal device 1014 from thermal exposure during torch operations, according to some embodiments of the present invention. The signal device 1014 can be substantially the same as the symmetrical ring-shaped signal device 914 of FIGS. 9a and b. The nozzle body can be substantially the same as the nozzle body of FIGS. 5a and 5b. As shown, the symmetrical ring-shaped signal device 1014 is disposed proximate the proximal end 504 of the laser nozzle 106.

A thermal regulation component 1010 is coupled to (or integrated) with the body of the laser nozzle 106 to provide thermal regulation of the signal device 1014. In the embodiment of FIGS. 10a and b, the thermal regulation component 1010 can be substantially the same as the thermal regulation component 910 of FIGS. 9a and b (e.g., having a circular channel 1016 filled with a thermally insulating material 1018 in physical contact with at least a portion of the signal device 1014 disposed therein), with the addition of a set of cooling fins 1020 dispersed circumferentially about the circular-shaped signal device 1014 along at least the inner diameter of the channel 1016 between the channel 1016 (including the signal device 1014) and the bore 502 of the laser nozzle 106. In some embodiments, the inner side wall and/or outer side wall of the channel 1016 are etched to form the cooling fins 1020. As shown, parallel cooling passages can be formed by adjacent pairs of the cooling fins 1020, where the cooling passages are evenly distributed circumferentially around the circular signal device 1014 to provide even cooling of the signal device 1014.

FIG. 10b shows an active coolant flow path 1022 through the cooling fins 1020 of the thermal regulation component 1010 while the laser torch is being operated. As shown, a coolant fluid (e.g., a cooling gas, a cooling liquid, a cooling mist, etc.) is provided via inlets of the passages formed by the cooling fins 1020 that are dispersed around the inner diameter of the channel 1016. The coolant fluid is adapted to flow axially in a laminar and/or turbulent flow pattern through these passages and exit the passages outwardly away from the laser nozzle 106 and the signal device 1014 as guided by the curved shape of the passages/fins 1020. This thermal regulation configuration is adapted to avoid interference and/or influence on the cutting outcome at the distal end 506 of the nozzle 106 by directing the heated coolant fluid outwardly away from the signal device 1014. In addition, because the passages of the cooling fins 1020 are located at and/or adjacent to one or more surfaces of the signal device 1014 (e.g., along one side surface and the distal surface of the signal device 1014 as shown in FIG. 10b), they provide even and close cooling of the signal device 1014. Overall, the radially symmetrical thermal regulation component 1010, including the circular channel 1016, the potting material 1018 and the circumferentially disposed cooling fins 1020, all combine to enable substantially even cooling of the signal device 1014.

FIGS. 11a-c show a perspective view, a cross-sectional view and a partial cutaway end view, respectively, of yet another exemplary design of the laser nozzle 106 of FIG. 1 for protecting a signal device 1114 from thermal exposure during torch operations, according to some embodiments of the present invention. The signal device 1014 can be substantially the same as the symmetrical ring-shaped signal device 914 of FIGS. 9a and b. The nozzle body can be substantially the same as the nozzle body of FIGS. 5a and 5b. As shown, the symmetrical ring-shaped signal device 1114 is disposed proximate the proximal end 504 of the laser nozzle 106.

A thermal regulation component 1110 is coupled to (or integrated) with the body of the laser nozzle 106 to provide thermal regulation of the signal device 1114. In the embodiment of FIGS. 11a-c, the thermal regulation component 1110 can be substantially the same as the thermal regulation component 910 of FIGS. 9a and b (e.g., having a circular channel 1116 filled with a thermally insulating material 1117 in physical contact with at least a portion of the signal device 1114 disposed therein), with the addition of an annular coolant passage 1118 disposed on or proximate to a distal surface 1102 of the signal device 1114. The annular coolant passage 1118 can be formed adjacent to the proximal end 504 of the nozzle body and configured to circulate a coolant fluid within laser nozzle 106 and across a portion of the distal surface 1102 of signal device 1114 and/or thermally insulating material 1117. As shown, the annular coolant passage 1118 has an inlet 1120 and an outlet 1122 that are disposed substantially radially opposite relative to each other around a circumference of the nozzle 106, both of which can be located adjacent to the inner diameter of the channel 1116.

FIGS. 11b and c show an active coolant flow path 1124 through the annular coolant passage 1118 of the thermal regulation component 1010 while the laser torch is being operated. As shown, a coolant fluid (e.g., a cooling gas, a cooling liquid, a cooling mist, etc.) is introduced axially in a distal direction into the coolant passage 1118 via the inlet 1120. The coolant fluid is adapted to flow axially past the signal device 1114 (e.g., between one side surface 1102 of the signal device 1114 and the nozzle body) to enter the annular coolant passage 1118. The coolant fluid then flows circumferentially within the annular coolant passage 1118 between the distal surface 1102 of the signal device 1114 and the nozzle body before reaching the outlet 1122 located radially opposite from the inlet 1120 for exhaustion. The heated coolant fluid is then exhausted axially away in a proximal direction by the outlet 1122. The exhausted coolant fluid can exit the nozzle 106 into a mating component (not shown) of the thermal processing torch or to atmosphere via a gap between the nozzle 106 and the mating component. Even though only one inlet 1120 and one outlet 1122 are illustrated in FIGS. 11a-c, a person of ordinary skill in the art understands that there can be any number of inlets and outlets. FIG. 11c highlights the circumferential flow path 1124 of the coolant fluid while within the annular coolant passage 1118. As shown, this portion of the flow path 1124 is radially around the bore 502 while axially between the signal device 1104 and the body of the nozzle 106.

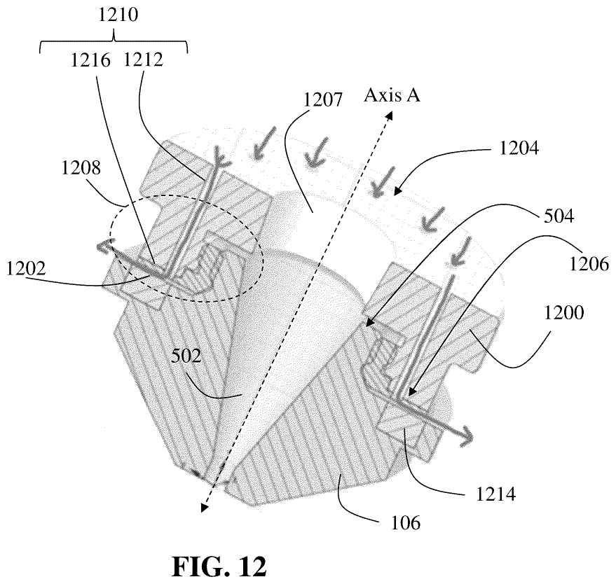

FIG. 12 shows a cross-sectional view of a nozzle holder 1200 attached to the laser nozzle 106 of FIG. 1 to protect a signal device 1214 in the nozzle 106 from thermal exposure during torch operations, according to some embodiments of the present invention. The signal device 1214 can be substantially the same as the symmetrical ring-shaped signal device 914 of FIGS. 9a and b. The nozzle can be substantially the same as the nozzle 106 of FIGS. 5a and 5b. As shown, the symmetrical ring-shaped signal device 1214 is disposed circumferentially around the nozzle bore 502 adjacent to the proximal end 504 of the laser nozzle 106. In some embodiments, the signal device 1214 is located within the nozzle body such that a proximal surface 1202 of the signal device 1214 is exposed when the nozzle 106 is not installed. The nozzle holder 1200 has a body defining a central longitudinal axis A extending between a proximal end 1204 and a distal end 1206, where the distal end 1206 is configured to be attached to the proximal end 504 of the laser nozzle 106 to connect the body of the laser nozzle 106 to the remaining components of the thermal processing torch. More specifically, the distal end 1206 of the nozzle holder 1200 is shaped to complement the proximal end 504 of the body of the laser nozzle 106 to form an interface 1208 therebetween. In addition, the nozzle holder 1200 includes a central bore 1207 disposed about the central longitudinal axis A.

In the embodiment of FIG. 12, the thermal regulation component 1210 is coupled to (or integrated with) the body of the nozzle holder 1200 to provide thermal regulation of the signal device 1214 disposed in (or integrated with) the nozzle 106. In this embodiment, the thermal regulation component 1210 comprises a set of coolant ports and coolant flow passages defined within the nozzle holder 1200, which will be explained below in detail. These ports and passages cooperatively deliver a coolant fluid to the interface 1208 proximate to the signal device 1214 that is embedded in the nozzle 106, such as over the proximal surface 1202 of the signal device 1214. In the embodiment of FIG. 12, the thermal regulation component 1210 is located solely in the nozzle holder 1200 without the coolant fluid entering the nozzle 106 nor requiring special thermal regulation features in the laser nozzle 106 itself. Alternatively, portions of the thermal regulation component 1210 can be distributed between the nozzle holder 1200 and the nozzle 106 to cooperatively cool the signal device 1214.

As shown in FIG. 12, the thermal regulation component 1210 of the nozzle holder 1200 includes a set of axial holes 1212 formed (e.g., drilled) into the body of the nozzle holder 1200 and circumferentially dispersed around the central bore 1207, where the inlets of these axial holes 1212 are disposed on the proximal surface 1204 of the nozzle holder 1200. The thermal regulation component 1210 also includes an annular groove 1216 located at the distal end 1206 of the nozzle holder 1200 and formed along the interface 1208 between the nozzle holder 1200 and the nozzle 106. The annular groove 1216, which extends around the central bore 1207, is in fluid communication with the axial holes 1212. During active cooling, a coolant fluid is supplied to the axial holes 1212 via their respective inlets, from which the coolant fluid is adapted to flow axially in the distal direction toward the outlets of the axial holes 1212, which are in fluid communication with the annular groove 1216. Upon entering the annular groove 1216, the annular groove 1216 is configured to conduct the coolant fluid radially outward to exhaust the coolant fluid from the assembly while contact cooling the proximal surface 1202 of the signal device 1214 that is located at the interface 1208. In some embodiments, the annular groove 1216 is configured to allow the coolant fluid to flow proximate the signal device 1214 and out from the side of the assembly without entering the laser nozzle 106 itself, thus obviating manufacturing complexity in design of the laser nozzle 106. In some embodiments, the cooling features of the thermal regulation component 1210 (e.g., offset holes 1212, slots forming the annular groove 1208, etc.) of the nozzle holder 1200 are formed through a ceramic material.

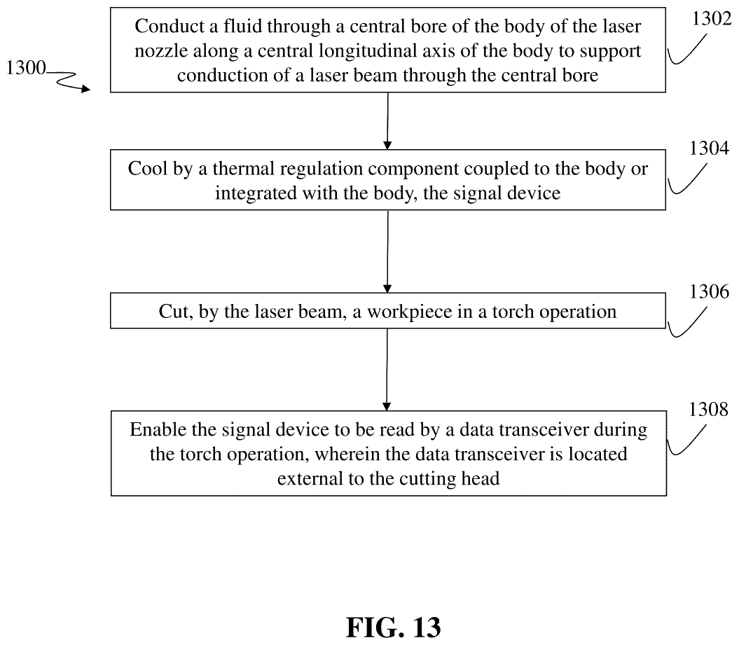

FIG. 13 shows an exemplary process 1300 for thermally regulating a signal device coupled to or integrated with a body of a laser nozzle 106 in connection with the laser cutting system 100 of FIG. 1 and employing one or more thermal regulation designs of FIGS. 5a-12, according to some embodiments of the present invention. The signal device can be radially symmetrical (e.g., ring-shaped) and disposed circumferentially about the central longitudinal axis of the body of the nozzle 106 (e.g., signal device 1014, 1114, 1214 of FIGS. 10a and b, FIGS. 11a-c, FIG. 12). Alternatively, the signal device can be radially-asymmetrical (e.g., cuboid-shaped) and disposed asymmetrically relative to the central longitudinal axis of the body of the nozzle 106 (e.g., signal devices 614, 714, 814 of FIGS. 6a and b, FIGS. 7a-c, FIGS. 8a-d, respectively). A thermal regulation component (e.g., the thermal regulation component described above with reference to FIGS. 5a-12) can be coupled to or integrated with the body of the nozzle 106 to offer thermal protection of the signal device. The thermal regulation component can be any one of the thermal regulation components described above with reference to FIGS. 5a-12 and/or suitably adapted to (e.g., mixed and matched) be compatible with the shape and/or location of the signal device.

The process 1300 starts at step 1302 with initiating an operation of the laser cutting torch 102 by conducting a fluid through the central bore 502 of the body of the laser nozzle 106 of the torch 102 along the central longitudinal axis A of the nozzle body to support conduction of a laser beam through the central bore 502.

At step 1304, the thermal regulation component can cool the signal device associated with the laser nozzle 106 during the torch operation via one or more means described above with reference to FIGS. 5a-12. As well understood by a person of ordinary skill in the art, the various embodiments of the thermal regulation component described above with reference to FIGS. 5a-12 can be easily mixed and matched or otherwise adapted to offer thermal protection for different shaped signal devices. For example, the thermal regulation component can be designed to include a set of one or more coolant passages located adjacent to at least one surface of the signal device. The set of coolant passages can direct a coolant fluid therethrough to thermally regulate either a radially asymmetric signal device (e.g., the cuboid signal devices 614, 714, 814 of FIGS. 6a and b, FIGS. 7a-c, FIGS. 8a-d, respectively) or a radially symmetrical signal device (the ring-shaped signal device 1014, 1114, 1214 of FIGS. 10a and b, FIGS. 11a-c, FIG. 12). For example, directing the coolant fluid by the set of coolant passages can comprise directly impinging the coolant fluid on at least one surface of the signal device or cooling a region close to the signal device. The set of coolant passages can comprise at least one inlet for receiving a coolant fluid for cooling the signal device and at least one outlet for exhausting the heated coolant fluid away from the signal device back to the torch head and/or to atmosphere. The set of coolant passages can be in the form of a manifold (e.g., FIG. 7a-b), a set of cooling fins (e.g., FIGS. 8a-d, FIGS. 10a and b) and/or a coolant channel that are designed to circulate the coolant fluid circumferentially and/or axially (relative to the longitudinal axis A of the nozzle body) proximate the signal device to cool and/or insulate the signal device (e.g., FIGS. 11a and b, FIG. 12). In addition, the thermal regulation component can be coupled to (or integrated with) the nozzle 106, the nozzle holder 1200, or a combination of the two. In some embodiments, in addition to or in place of the coolant passages, the thermal regulation component can comprise a thermally insulating material to cool the signal device (e.g., FIGS. 5a and b, FIGS. 9a and b). In some embodiments, in addition to or in place of the coolant passages and/or the thermally insulating material, the thermal regulation component can comprise a shielding element configured to physically block a line-of-sight access between the signal device and the workpiece. In some embodiments, the thermal regulation component is fluidly separated from the central bore of the laser nozzle such that the coolant fluid and/or the thermally insulating material of the thermal regulation component is separated from the fluid in the central bore without intermingling.

At step 1306, the laser cutting torch 102 is adapted to process (e.g., cut) the workpiece by delivering the laser beam to the workpiece. Because the thermal regulation component is configured to protect the signal device from thermal loads during the torch operation, the transceiver 108, which can be located external to the cutting head 112 of the torch 102, is able to successfully read from the data storage component 202 of the signal device during the torch operation at step 1308. In some embodiments, the transceiver 108 also writes data to the data storage component 202 of the signal device during the same torch operation. The transceiver 108 can be located outside of the torch 102 (e.g., greater than about one foot away from the body of the nozzle 106), such as integrated with one of a nozzle changer, an inspection station or a portable reader.

In general, the present invention relates to coupling or integrating a signal device to a laser nozzle or a nozzle holder, which offers several advantages including simplifying the laser cutting system 100 by eliminating the need for integration with the laser head 112 or upstream components when the transceiver 108 is located at a distance external to the torch 102. Such a simplification can be enhanced when the system 100 is configured to read data from or write data to multiple signal devices substantially simultaneously at a distance. In addition, the present invention features various designs (e.g., cooling features and means) that reduce and/or solve overheating of the signal devices within laser cutting nozzles during torch operations and prevent thermal damage thereto. Furthermore, the present invention permits automated delivery of optimized cut recipes from the processor 110 to the torch 102 based on information stored in the signal device associated with at least one consumable of the torch 102, such as consumable brand/source identification information, consumable type, consumable condition, etc., which can be used by the processor 110 to customize cut recipes that minimize human errors and enhance resulting cut qualities.

It is understood that various aspects and embodiments of the invention can be combined in various ways. Based on the teachings of this specification, a person of ordinary skill in the art can readily determine how to combine these various embodiments. Modifications may also occur to those skilled in the art upon reading the specification.

What is claimed is:

1. A laser nozzle for a thermal processing torch located in a thermal processing system, the laser nozzle comprising:
a body defining a central bore extending along a central longitudinal axis of the body from a proximal end to a distal end of the body, wherein the central bore has an exit orifice and is configured to conduct a laser beam to a workpiece via the exit orifice to process the workpiece in a torch operation;
a signal device coupled to the body or integrated with the body, the signal device comprising a data storage element; and
a thermal regulation component coupled to the body or integrated with the body, the thermal regulation component located adjacent to the signal device to provide cooling to the signal device during the torch operation, thereby enabling the data storage element of the signal device to be readable by a data transceiver during the torch operation.

2. The laser nozzle of claim 1, wherein the signal device includes a radio-frequency identification (RFID) tag.

3. The laser nozzle of claim 2, wherein the RFID tag is an ultra-high frequency (UHF) RFID tag.

4. The laser nozzle of claim 1, wherein the laser beam produces at least about 2,000 Watts of power.

5. The laser nozzle of claim 1, wherein the signal device is radially symmetrical and is adapted to be disposed circumferentially about the central longitudinal axis of the body around the central bore.

6. The laser nozzle of claim 5, wherein the signal device is ring-shaped.

7. The laser nozzle of claim 1, wherein the signal device is disposed asymmetrically relative to the central longitudinal axis of the body.

8. The laser nozzle of claim 1, wherein the thermal regulation component comprises at least one coolant passage located adjacent to at least one surface of the signal device to circulate a flow of a coolant fluid proximate the signal device during the torch operation.

9. The laser nozzle of claim 8, wherein the coolant fluid is one of a liquid or a gas.

10. The laser nozzle of claim 8, wherein the at least one coolant passage is configured to thermally regulate a region of the laser nozzle away from the central longitudinal axis.

11. The laser nozzle of claim 10, wherein the thermally regulated region is radially asymmetrical relative to the central longitudinal axis.

12. The laser nozzle of claim 8, wherein the at least one coolant passage is fluidly separated from the central bore such that the flow of the coolant fluid through the at least one coolant passage is separated from a fluid flow through the central bore in support of the laser beam.

13. The laser nozzle of claim 8, wherein the at least one coolant passage is partially defined by the at least one surface of the signal device to enable direct impingement of the coolant fluid on the at least one surface.

14. The laser nozzle of claim 8, wherein the at least one coolant passage comprises a plurality of coolant passages forming a cooling manifold disposed between the signal device and the central bore.

15. The laser nozzle of claim 8, wherein the at least one coolant passage includes a plurality of cooling fins disposed into the body of the laser nozzle proximate the signal device, the cooling fins configured to conduct the coolant liquid therethrough to cool the signal device.

16. The laser nozzle of claim 8, wherein the at least one coolant passage includes at least one inlet for receiving the coolant fluid from the thermal processing torch and at least one outlet for exhausting the coolant fluid from the body of the laser nozzle.

17. The laser nozzle of claim 16, wherein the at least one outlet is located radially opposite from the at least one inlet relative to the central longitudinal axis.

18. The laser nozzle of claim 16, wherein the at least one coolant passage includes a passage configured to receive the coolant fluid from the at least one inlet, direct the coolant fluid to flow circumferentially about the central longitudinal axis, and provide the coolant fluid to the at least one outlet for exhaustion.

19. The laser nozzle of claim 16, wherein the at least one outlet is configured to exhaust the coolant fluid to one of the thermal processing torch or to atmosphere.

20. The laser nozzle of claim 1, wherein the thermal regulation component comprises a thermally insulating material configured to surround the signal device, and wherein at least a portion of the thermally insulating material is disposed between the signal device and a portion of the body of the laser nozzle.

21. The laser nozzle of claim 20, wherein the thermally insulating material comprises a potting compound.

22. The laser nozzle of claim 20, wherein at least a portion of the signal device protrudes from an external surface the body of the laser nozzle and is exposed to an external environment during the torch operation.

23. The laser nozzle of claim 1, the thermal regulation component comprises a shielding element configured to physically block a line-of-sight access between the signal device and the workpiece.

24. The laser nozzle of claim 1, further comprising a nozzle holder configured to connect the body of the laser nozzle to the thermal processing torch.

25. The laser nozzle of claim 24, wherein the nozzle holder defines a set of coolant ports configured to deliver a coolant fluid to the body of the nozzle.

26. The laser nozzle of claim 24, wherein a distal end of the nozzle holder is shaped to complement the proximal end of the body to form an interface that defines a set of coolant flow passages therebetween, the set of coolant ports and coolant flow passages cooperatively providing the coolant fluid proximate the signal device.

27. The laser nozzle of claim 1, wherein the data storage element of the signal device is both readable and writable.

28. The laser nozzle of claim 1, wherein the signal device is spaced at a distance between about 6 inches and about 7 feet from the data transceiver.

29. The laser nozzle of claim 1, wherein the data transceiver is integrated into one of a nozzle changer, an inspection station or a portable reader.

30. The laser nozzle of claim 1, wherein the thermal regulation component comprises a substantially circumferential channel formed adjacent to the proximal end of the body, wherein the circumferential channel is configured to receive a coolant fluid.

31. The laser nozzle of claim 1, wherein the signal device is configured to store an operation instruction for the thermal processing torch, the operation instruction transferable to the thermal processing system by the data transceiver.

32. The laser nozzle of claim 31, wherein the operation instruction is configured to produce an altered performance characteristic of the thermal processing torch relative to an original performance characteristic produced using the laser nozzle without transferring the operating instruction.

33. The laser nozzle of claim 1, wherein the signal device includes at least one of a pressure sensor or a strain gauge sensor coupled to or integrated with the nozzle body and configured to detect collision impact in a region of the laser nozzle at which the sensor is located.

34. The laser nozzle of claim 33, wherein the pressure sensor is a piezoelectric sensor configured to measure a pressure in the region so as to detect the collision impact.

35. The laser nozzle of claim 33, wherein the strain gauge sensor is configured to measure deformation or strain in the region so as to detect the collision impact.

36. The laser nozzle of claim 1, wherein the signal device includes a temperature sensor coupled to or integrated with the nozzle body and is configured to measure a temperature in a region of the laser nozzle at which the temperature sensor is located.

37. A method for thermally regulating a signal device coupled to or integrated with a body of a laser nozzle, the laser nozzle located in a cutting head of a laser processing torch of a laser processing system, the method comprising:
conducting a fluid through a central bore of the body of the laser nozzle along a central longitudinal axis of the body to support conduction of a laser beam through the central bore;
cooling, by a thermal regulation component coupled to the body or integrated with the body, the signal device;
cutting, by the laser beam, a workpiece in a torch operation; and
enabling the signal device to be read by a data transceiver during the torch operation, wherein the data transceiver is located external to the cutting head.

38. The method of claim 37, wherein the thermal regulation component comprises at least one coolant passage disposed within the body adjacent to at least one surface of the signal device.

39. The method of claim 38, wherein cooling the signal device comprises:
flowing a coolant fluid into at least one inlet in the laser nozzle that is radially offset from the central bore, the inlet fluidly connected to the at least one coolant passage of the thermal regulation component;
directing the coolant fluid to flow proximate the signal device via the at least one coolant passage; and
exhausting the coolant fluid from the body via at least one outlet of the laser nozzle, the outlet fluidly connected to the at least one coolant passage.

40. The method of claim 39, wherein the coolant fluid is one of a liquid or a gas.

41. The method of claim 39, further comprising flowing the coolant fluid through the at least one inlet, the at least one coolant passage and the at least one outlet without intermingling with the fluid conducted through the central bore.

42. The method of claim 39, wherein exhausting the coolant fluid comprises recirculating the coolant fluid into a laser head connected to the laser nozzle or exhausting the coolant fluid to atmosphere.

43. The method of claim 39, wherein directing the coolant fluid by the at least one coolant passage comprises directly impinging the coolant fluid on at least one surface of the signal device.

44. The method of claim 37, wherein the thermal regulation component comprises a thermally insulating material configured to surround the signal device, and wherein cooling the signal device comprises cooling the signal device by the thermally insulating material.

45. The method of claim 37, wherein the signal device is disposed circumferentially about the central longitudinal axis of the body.

46. The method of claim 37, wherein the signal device is disposed asymmetrically relative to the central longitudinal axis of the body.

47. The method of claim 37, further comprising writing, by the data transceiver, data to the signal device during the torch operation.

48. The method of claim 37, wherein the data transceiver is integrated with one of a nozzle changer, an inspection station or a portable reader.

49. The method of claim 38, further comprising measuring a physical characteristic of the laser nozzle by a sensor of the signal device during the torch operation, wherein the sensor is coupled to or integrated with the nozzle body.

50. The method of claim 49, wherein the sensor is a pressure sensor or a strain gauge sensor configured to measure a collision impact on a region of the laser nozzle at which the sensor is located.

51. The method of claim 50, wherein the pressure sensor is a piezoelectric sensor configured to measure a pressure in the region.

52. The method of claim 50, wherein the strain gauge sensor is configured to measure a stress value associated with a deformation or strain in the region.

53. The method claim 49, wherein the sensor is a temperature sensor configured to measure a temperature in a region of the laser nozzle at which the sensor is located.

54. The method of claim 50, further comprising transmitting the pressure measured by the pressure sensor or the stress value measured by the strain gauge sensor to a processor of the laser processing system to detect the collision impact.

55. The method of claim 53, further comprising transmitting the temperature measured by the temperature sensor to a processor of the laser processing system to detect a loss of cut.

56. A replaceable consumable component of a thermal processing torch located in a thermal processing system, the replaceable consumable component comprising:
a thermally conductive body defining a central bore extending along a central longitudinal axis of the body from a proximal end to a distal end of the body, wherein the central bore has an exit orifice and is configured to conduct a laser beam to a workpiece via the exit orifice during an operation of the thermal processing torch;
a signal device disposed in the thermally conductive body; and
an insulator comprising a thermally insulating material, the insulator disposed between the thermally conductive body and the signal device to thermally regulate the signal device,
wherein the signal device is readable by a data transceiver positioned greater than about one foot away from the body during the torch operation.
